(19) United States
(12) Patent Application Publication
(10) Pub. No.: US 2011/0161067 A1
(43) Pub. Date: Jun. 30, 2011

(54) SYSTEM AND METHOD OF USING POS TAGGING FOR SYMBOL ASSIGNMENT

(75) Inventors: GREG LESHER, PITTSBURGH, PA (US); BOB CUNNINGHAM, PITTSBURGH, PA (US)

(73) Assignee: DYNAVOX SYSTEMS, LLC, PITTSBURGH, PA (US)

(21) Appl. No.: 12/648,683

(22) Filed: Dec. 29, 2009

(51) Int. Cl. G06F 17/20

(52) U.S. Cl. 704/1; 704/E11.001

(57) ABSTRACT

Systems and methods for automatically discovering and assigning symbols for identified text in a software application include identifying text for which symbol assignment is desired. The words within the identified text and selected surrounding words defining an observation sequence are subjected to a part of speech tagging algorithm to electronically determine one or more most likely part of speech tags for the identified text. Context relations between the identified text and selected surrounding keywords may also be identified. The identified text, part of speech tag(s) and/or determined relations are then analyzed to map the identified text to one or more identified word senses. Related word senses may also be analyzed to determine if any related word senses have symbols. One of the determined symbols may then be associated with the identified text such that the symbol is thereafter displayed in conjunction with or instead of the text in the application.

### CROSS-REFERENCE TO RELATED APPLICATIONS

N/A

### STATEMENT REGARDING FEDERALLY SPONSORED RESEARCH OR DEVELOPMENT

N/A

### BACKGROUND

The presently disclosed technology generally pertains to systems and methods for linguistic analysis, and more particularly to features for automatically assigning symbols to text in an instructional application.

Many software-based reading and/or writing instructional applications utilize symbols in addition to text to represent words or other portions of language. Sometimes, instructional software authoring tools can help a user generate printed materials that combine text and symbols to help create symbol-based communication and/or educational tools. One example of a symbol-based desktop publishing software used for the creation of printed materials corresponds to BOARDMAKER® software offered by DynaVox Mayer-Johnson of Pittsburgh, Pa.

Symbol-based instructional software authoring tools have become useful not only for the generation of printed educational and communication materials, but also for integration with electronic devices that facilitate user communication and instruction. For example, electronic devices such as speech generation devices (SGDs) or Alternative and Augmentative Communication (AAC) devices can include a variety of features to assist with a user's communication.

Such devices are becoming increasingly advantageous for use by people suffering from various debilitating physical conditions, whether resulting from disease or injuries that may prevent or inhibit an afflicted person from audibly communicating. For example, many individuals may experience speech and learning challenges as a result of pre-existing or developed conditions such as autism, ALS, cerebral palsy, stroke, brain injury and others. In addition, accidents or injuries suffered during armed combat, whether by domestic police officers or by soldiers engaged in battle zones in foreign theaters, are swelling the population of potential users. Persons lacking the ability to communicate audibly can compensate for this deficiency by the use of speech generation devices.

In general, a speech generation device may include an electronic interface with specialized software configured to permit the creation and manipulation of digital messages that can be translated into audio speech output. The messages and other communication generated, analyzed and/or relayed via an SGD or AAC device may include symbols or text alone or in some combination. In one example, messages may be composed by a user by selection of buttons, each button corresponding to a graphical user interface element composed of some combination of text and/or graphics to identify the text or language element for selection by a user.

In order to better facilitate the use of communication “buttons” and other graphical interface features for use in SGD or AAC devices, as well as in other symbol-assisted reading and/or writing instructional applications, the automated creation and adaptation of such elements can be further improved. In light of the various uses of symbol-based communication technologies, a need continues to exist for refinements and improvements to address such concerns. While various implementations of speech generation devices and associated features have been developed, no design has emerged that is known to generally encompass all of the desired characteristics hereafter presented in accordance with aspects of the subject technology.

### BRIEF SUMMARY

In general, the present subject matter is directed to various exemplary speech generation devices (SGD) or other electronic devices having improved configurations for providing selected AAC features and functions to a user.

More specifically, the present subject matter provides improved features and steps for associating and automatically discovering and/or assigning symbols to selected text. Such associations can be advantageous because symbols may be used to represent words, names, phrases, sentences and other messages to provide some individuals with a communication environment in which vocabulary choices can be made effectively and independently. Symbols provide an opportunity for people who are not literate or who are still developing literacy skills to have an effective representation of words and thoughts for speech or written communication.

In one exemplary embodiment, a method of automatically discovering and assigning symbols for identified text in a software application includes a first step of receiving electronic signals from identifying text for which symbol assignment is desired. Text may be provided by a user as electronic input to a processing device or may be selected from pre-existing, downloaded, imported or other electronic data accessible by a processing device. The text is preferably provided in context such that subsequent part of speech analysis can consider not only the text for which symbol assignment is desired, but surrounding words in a sentence, phrase, or other sequence of words. The identified text is then subjected to a part of speech tagging algorithm to electronically determine one or more most likely part of speech tags for the identified text. The identified text and selected surrounding keywords may be analyzed further to determine potential relations among the words. Next, the identified text and the one or more most likely part of speech tags are electronically analyzed to automatically establish a mapping of the identified text to one or more identified word senses.

Matched word senses then may be analyzed further to determine if a matched word sense has an associated symbol. If so, then the identified matching symbol can be automatically associated with the identified text. Alternatively, the identified matching symbol may be displayed graphically to a user for confirmation of association with the analyzed text. If multiple symbols are matched then such multiple symbols may be displayed graphically to a user to prompt user selection of the desired symbol selection. The symbol then may be displayed with or without the text as visual output to a user. For example, once an identified symbol is associated, the text may from that point forward be represented in the system as an icon including the symbol with or without the associated text.

If no matching word sense has an associated symbol, then a determination may be made regarding whether selected related word senses have any associated symbols. Selection of related word senses can be structured relative to a given word sense by type of relation (e.g., “kind of”, “instance of”, “part of”, etc.). Some of those relations (e.g., “kind of”, “part of”, etc.) can be further defined by a direction of relation (e.g., general or specific), number of degrees of relational separation, etc. If one or more selected related word senses are determined to have an associated symbol, then some or all of such symbols can be associated with the identified text and displayed as visual output to a user. In some embodiments, the symbols for related words may be automatically or manually modified (e.g., to reflect the type of relation between the identified word sense and related word sense.) If selected word sense relations are exhausted and no associated symbols are found, then additional steps can be taken. For example, an optional step may involve providing a symbol menu or other graphical user interface to a user so that the user can manually select a pre-existing or imported symbol for the text, create a symbol from scratch or from predefined symbol selection or creation features, or modify an existing or imported symbol.

In some more particular exemplary embodiments of the subject technology, the part of speech tags assigned in accordance with the disclosed symbol assignment techniques are selected from a tagset indicating basic parts of speech as well as syntactic or morpho-syntactic distinctions. Such a tagset may, for example, include between 20 and 100 possible tags or more depending on the language and needs of the tagging analysis. In one embodiment, the part of speech tagging involves extracting an observation sequence of text including the identified text and surrounding words from context, and assigning the most likely part of speech tag for each word in the observation sequence. The latter assigning can be done, for example, using a first-order or second-order Viterbi algorithm to implement a bigram or trigram HMM-based POS tagger with or without probabilistic enhancements afforded by a forward-backward algorithm. In another embodiment, the part of speech tagging involves extracting an observation sequence of text including the identified text and surrounding words and generating a list of possible tags and corresponding probabilities of occurrence for one or more words in the identified text. This list can then be used to help identify most likely symbols for the identified text.

It should be appreciated that still further exemplary embodiments of the subject technology concern hardware and software features of an electronic device configured to perform various steps as outlined above. For example, one exemplary embodiment concerns a computer readable medium embodying computer readable and executable instructions configured to control a processing device to implement the various steps described above or other combinations of steps as described herein.

In a still further example, another embodiment of the disclosed technology concerns an electronic device, such as but not limited to a speech generation device, including such hardware components as a processing device, at least one input device and at least one output device. The at least one input device may be adapted to receive electronic input from a user regarding selection or identification of text to which symbol assignment is desired. The processing device may include one or more memory elements, at least one of which stores computer executable instructions for execution by the processing device to act on the data stored in memory. The instructions adapt the processing device to function as a special purpose machine that determines one or more most likely part of speech tags for the identified text, analyzes the identified text and the one or more most likely part of speech tags for the identified text to automatically establish a mapping of the identified text to one or more identified word senses, and determines whether any of the identified word senses has an associated symbol. Once one or more symbols are found, they may be provided on a display in combination with the text and/or other visual features or action items for user confirmation. The mapped symbol to text assignment is then stored for later use within the electronic device.

Additional aspects and advantages of the disclosed technology will be set forth in part in the description that follows, and in part will be obvious from the description, or may be learned by practice of the technology. The various aspects and advantages of the present technology may be realized and attained by means of the instrumentalities and combinations particularly pointed out in the present application.

### BRIEF DESCRIPTION OF THE DRAWINGS

The accompanying drawings, which are incorporated in and constitute a part of this specification, illustrate one or more embodiments of the presently disclosed subject matter. These drawings, together with the description, serve to explain the principles of the disclosed technology but by no means are intended to be exhaustive of all of the possible manifestations of the present technology.

FIG. 1 provides a flow chart of exemplary steps in a method of automatically discovering and assigning symbols using a word sense model database in accordance with aspects of the presently disclosed technology;

FIG. 2 provides an exemplary collection of graphical interface elements illustrating multiple exemplary text portions and associated symbols for display in accordance with aspects of the presently disclosed technology;

FIG. 3 provides a schematic illustration of exemplary word relations such as may be stored as part of word sense and/or language databases for use in accordance with aspects of the presently disclosed technology;

FIG. 4 provides a schematic view of exemplary hardware components for use in an exemplary electronic device having symbol assignment features in accordance with aspects of the presently disclosed technology;

FIG. 5 provides a schematic view of exemplary hardware components for use in an exemplary speech generation device having symbol assignment features in accordance with aspects of the presently disclosed technology;

FIG. 6 provides a flow chart of exemplary steps in a part of speech tagging algorithm by which parts of speech are assigned to the words in the identified text and selected surrounding words; and

FIG. 7 provides a flow chart of exemplary steps in a relation determination step by which target words in the identified text are compared to selected surrounding keywords in context.

### DETAILED DESCRIPTION OF THE PREFERRED EMBODIMENTS

Reference now will be made in detail to the presently preferred embodiments of the disclosed technology, one or more examples of which are illustrated in the accompanying drawings. Each example is provided by way of explanation of the technology, which is not restricted to the specifics of the examples. In fact, it will be apparent to those skilled in the art that various modifications and variations can be made in the present subject matter without departing from the scope or spirit thereof. For instance, features illustrated or described as part of one embodiment, can be used on another embodiment to yield a still further embodiment. Thus, it is intended that the presently disclosed technology cover such modifications and variations as may be practiced by one of ordinary skill in the art after evaluating the present disclosure. The same numerals are assigned to the same or similar components throughout the drawings and description.

The technology discussed herein makes reference to processors, servers, memories, databases, software applications, and/or other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein may be implemented using a single server or processor or multiple such elements working in combination. Databases and other memory/media elements and applications may be implemented on a single system or distributed across multiple systems. Distributed components may operate sequentially or in parallel. All such variations as will be understood by those of ordinary skill in the art are intended to come within the spirit and scope of the present subject matter.

When data is obtained or accessed between a first and second computer system, processing device, or component thereof, the actual data may travel between the systems directly or indirectly. For example, if a first computer accesses a file or data from a second computer, the access may involve one or more intermediary computers, proxies, or the like. The actual file or data may move between the computers, or one computer may provide a pointer or metafile that the second computer uses to access the actual data from a computer other than the first computer.

The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein also may be implemented by hard-wired logic or other circuitry, including, but not limited to application-specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods. As noted above, such devices may access one or more computer-readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

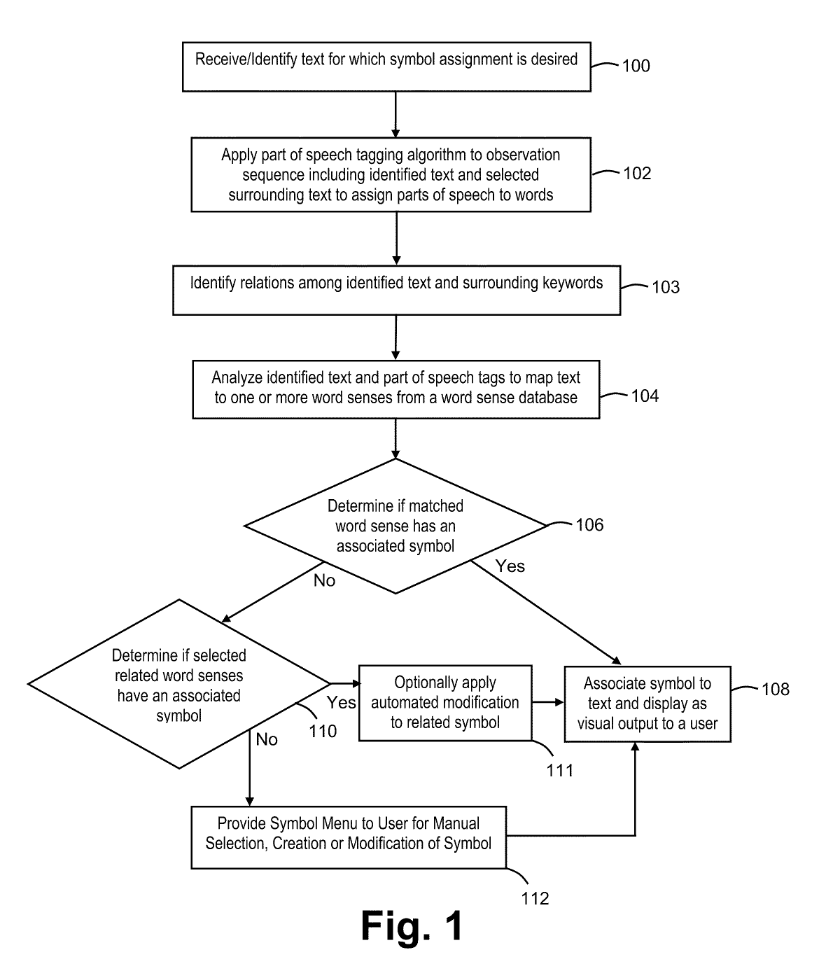

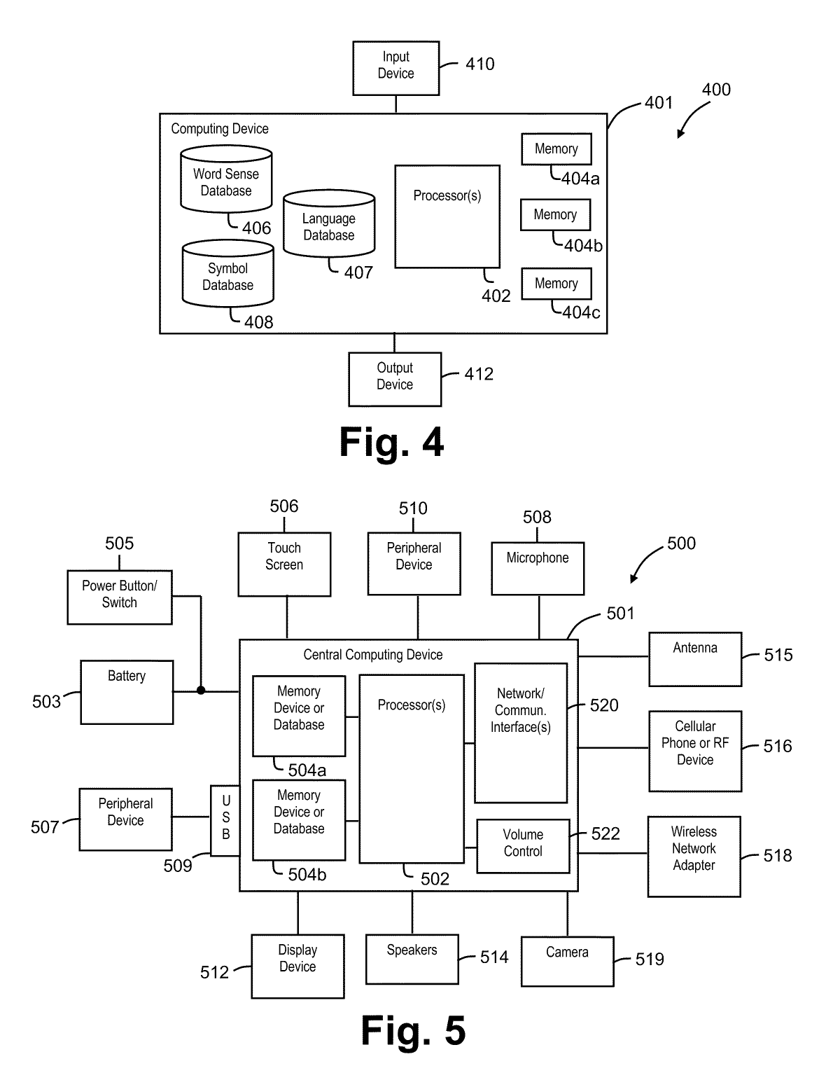

Referring now to the drawings, FIG. 1 provides a schematic overview of an exemplary method of using a word sense model database for symbol assignment in accordance with aspects of the presently disclosed technology. The steps provided in FIG. 1 and other figures herein may be performed in the order shown in such figure or may be modified in part, for example to exclude optional or non-optional steps or to perform steps in a different order than shown in FIG. 1. The steps shown in FIG. 1 are part of an electronically-implemented computer-based algorithm. Computerized processing of electronic data in a manner as set forth in FIG. 1 may be performed by a special-purpose machine corresponding to some computer processing device configured to implement such algorithm. Additional details regarding the hardware provided for implementing such computer-based algorithm are provided in FIGS. 4 and 5.

A first exemplary step 100 in the method of FIG. 1 is to receive and/or otherwise indicate identified text for which symbol assignment is desired. Text may be provided by a user as electronic input to a processing device or may be selected from pre-existing, downloaded, imported or other electronic data accessible by a processing device. Identified text from step 100 may contain one or more words, symbols, alphanumeric identifiers and the like. Step 102 then involves applying a part of speech tagging algorithm to an observation sequence including the identified text and optional additional surrounding words or context such that one or more most likely part of speech tags for the identified text can be determined.

A variety of different models and methods can be used to implement the part of speech tagging step 102 identified in FIG. 1. In general, a part of speech tagging algorithm assigns each word in a sentence or other subset of text with a tag describing how that word is used in the sentence. The set of tags assigned by a part of speech tagger may contain just a few tags or many hundreds of tags. In one example, tagsets used for English language tagging may include anywhere between 20-100 tags or more, or between 50-150 tags in another example. Larger tagsets with several hundred tags may be used for morphologically rich languages like German, French, Chinese, etc. where the number, gender and case features of nouns, adjectives, and determiners lead to a wide variety in the number of possible tags. One example as set forth below in Table 1 is the CLAWS5 (Constituent Likelihood Automatic Word-tagging System) tagset developed by UCREL of Lancaster University in Lancaster, United Kingdom. It should be appreciated that such exemplary tagset and others as may be utilized herein include a sufficient amount of tags to distinguish among different basic parts of speech as well as syntactic and/or even morpho-syntactic distinctions among such parts of speech.

TABLE 1
Exemplary Tagset with Part of Speech Tags

| Tag: | Tag Type/Description (Examples): |
|---|---|
| AJ0 | adjective (unmarked) (e.g. GOOD, OLD) |
| AJC | comparative adjective (e.g. BETTER, OLDER) |
| AJS | superlative adjective (e.g. BEST, OLDEST) |
| AT0 | article (e.g. THE, A, AN) |
| AV0 | adverb (unmarked) (e.g. OFTEN, WELL, LONGER, |
| | FURTHEST) |
| AVP | adverb particle (e.g. UP, OFF, OUT) |
| AVQ | wh-adverb (e.g. WHEN, HOW, WHY) |
| CJC | coordinating conjunction (e.g. AND, OR) |
| CJS | subordinating conjunction (e.g. ALTHOUGH, WHEN) |
| CJT | the conjunction THAT |
| CRD | cardinal numeral (e.g. 3, FIFTY-FIVE, 6609) (excl ONE) |
| DPS | possessive determiner form (e.g. YOUR, THEIR) |
| DT0 | general determiner (e.g. THESE, SOME) |
| DTQ | wh-determiner (e.g. WHOSE, WHICH) |
| EX0 | existential THERE |
| ITJ | interjection or other isolate (e.g. OH, YES, MHM) |
| NN0 | noun (neutral for number) (e.g. AIRCRAFT, DATA) |
| NN1 | singular noun (e.g. PENCIL, GOOSE) |
| NN2 | plural noun (e.g. PENCILS, GEESE) |
| NP0 | proper noun (e.g. LONDON, MICHAEL, MARS) |
| NULL | the null tag (for items not to be tagged) |
| ORD | ordinal (e.g. SIXTH, 77TH, LAST) |
| PNI | indefinite pronoun (e.g. NONE, EVERYTHING) |
| PNP | personal pronoun (e.g. YOU, THEM, OURS) |
| PNQ | wh-pronoun (e.g. WHO, WHOEVER) |
| PNX | reflexive pronoun (e.g. ITSELF, OURSELVES) |
| POS | the possessive (or genitive morpheme) 'S or ' |
| PRF | the preposition OF |
| PRP | preposition (except for OF) (e.g. FOR, ABOVE, TO) |
| PUL | punctuation - left bracket (i.e. ( or [) |
| PUN | punctuation - general mark (i.e. . ! , : ; - ? . . .) |
| PUQ | punctuation - quotation mark (i.e. ‘ ′ ″) |
| PUR | punctuation - right bracket (i.e.) or ]) |
| TO0 | infinitive marker TO |
| UNC | “unclassified” items which are not words of the English lexicon |
| VBB | the “base forms” of the verb “BE” (except the infinitive), |
| | i.e. AM, ARE |
| VBD | past form of the verb “BE”, i.e. WAS, WERE |
| VBG | -ing form of the verb “BE”, i.e. BEING |
| VBI | infinitive of the verb “BE” |
| VBN | past participle of the verb “BE”, i.e. BEEN |
| VBZ | -s form of the verb “BE”, i.e. IS, 'S |
| VDB | base form of the verb “DO” (except the infinitive), i.e. |
| VDD | past form of the verb “DO”, i.e. DID |
| VDG | -ing form of the verb “DO”, i.e. DOING |
| VDI | infinitive of the verb “DO” |
| VDN | past participle of the verb “DO”, i.e. DONE |
| VDZ | -s form of the verb “DO”, i.e. DOES |
| VHB | base form of the verb “HAVE” (except the infinitive), |
| | i.e. HAVE |
| VHD | past tense form of the verb “HAVE”, i.e. HAD, 'D |
| VHG | -ing form of the verb “HAVE”, i.e. HAVING |
| VHI | infinitive of the verb “HAVE” |
| VHN | past participle of the verb “HAVE”, i.e. HAD |
| VHZ | -s form of the verb “HAVE”, i.e. HAS, 'S |
| VM0 | modal auxiliary verb (e.g. CAN, COULD, WILL, 'LL) |
| VVB | base form of lexical verb (except the infinitive)(e.g. TAKE, |
| | LIVE) |
| VVD | past tense form of lexical verb (e.g. TOOK, LIVED) |
| VVG | -ing form of lexical verb (e.g. TAKING, LIVING) |
| VVI | infinitive of lexical verb |
| VVN | past participle form of lex. verb (e.g. TAKEN, LIVED) |
| VVZ | -s form of lexical verb (e.g. TAKES, LIVES) |
| XX0 | the negative NOT or N'T |
| ZZ0 | alphabetical symbol (e.g. A, B, c, d) |

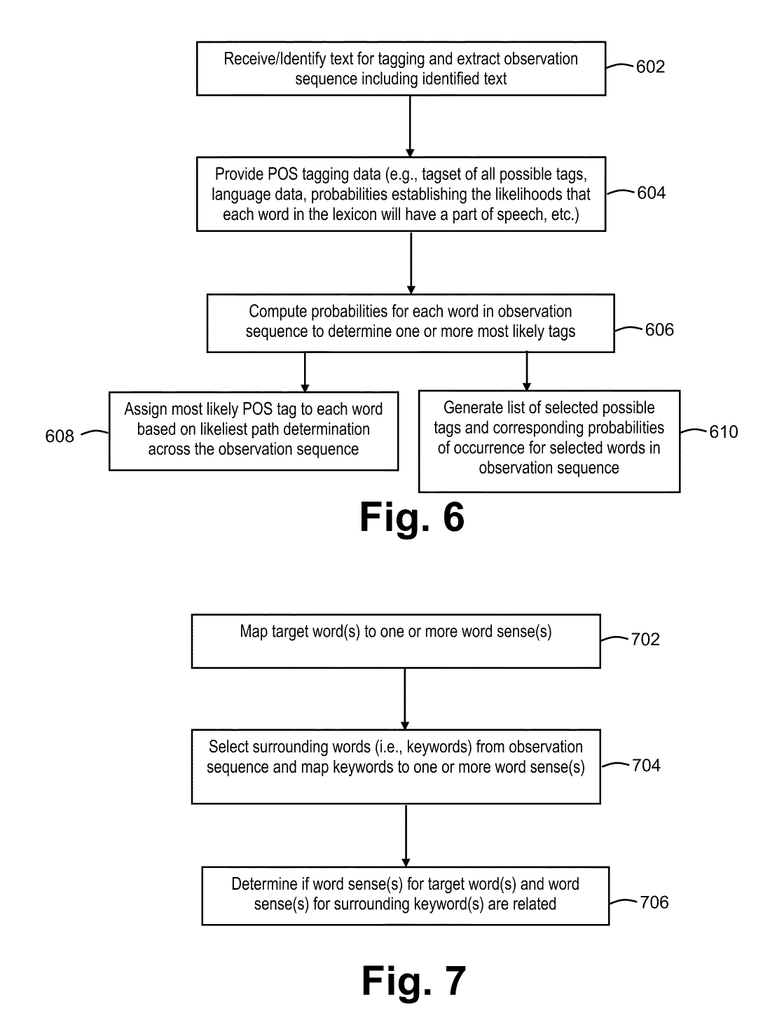

Some examples of part-of-speech tagging algorithms that can be used include but are not limited to hidden Markov models (HMMs), log-linear models, transformation-based systems, rule-based systems, memory-based systems, maximum-entropy systems, support vector systems, neural networks, decision trees, manually written disambiguation rules, path voting constraint systems, linear separator systems, and majority voting systems. The typical accuracy of POS taggers may be between 95% and 98% depending on the tagset, the size of the training corpus, the coverage of the lexicon, and the similarity between training and test data. Additional details regarding suitable examples of the part of speech tagging algorithm applied in step 102 are presented later with respect to FIG. 6.

Referring still to FIG. 1, another step that may be implemented in embodiments of the present technology includes a step 103 of identifying potential relations among identified text and surrounding keywords in context. For example, assuming the identified text corresponds to one or more target words, other selected keywords in the sentence or surrounding text may be considered to help determine ultimately if the identified text is more likely to correspond to one word sense than another when multiple word senses are available. The contextual analysis performed in step 103, just like the POS tag(s) obtained in step 102, thus adds an additional word sense disambiguation feature for the word sense mapping in step 104. More particular details of the keyword contextual analysis of step 103 is presented in FIG. 7.

Step 104 involves analyzing the text identified in step 100 as well as the part(s) of speech determined in step 102 and/or relations identified in step 103 for each word in the identified text to map the identified text to one or more identified word senses from a word sense model database. Word senses generally correspond to the meanings of a word, such as when multiple meanings exist for the same word or text.

To better understand steps 100-104, respectively, consider a situation in which the subject system and method receives the text “bat” from a user as a word to which a user wants to assign a symbol. The system may then identify an observation sequence of text or context in which “bat” was used. In a typical situation, the observation sequence corresponds to the sentence the identified text was used in. For example, consider that the word “bat” was used in a sentence as follows: “The baseball player swung the bat like he was in the World Series.” Some or all of this sentence may then be subjected to a part of speech tagging algorithm in step 102 to determine that the word “bat” identified in step 100 is a singular noun. The text and the identified part of speech can then be used in identification and mapping of the “bat” to one or more word senses. For example, the following word senses and some or all of the related information listed in Table 2 may exist for the text “bat” in a word sense and/or language database. If the part of speech was identified in step 102 as some form of noun, then the analysis in step 104 could narrow down possible word senses for the text “bat” to senses (1), (2) or (3) in Table 2. If the sentence contains other keywords such as “baseball,” then the results of a relation determination in step 103 may help map the text “bat” to word sense (2) in the list above.

TABLE 2
Exemplary Information from a Word Sense Database
when Searched for Text “bat”

| | Word | Part of | |
|---|---|---|---|
| | Sense: | Speech: | Word Sense Description: |
| (1) | Bat | Noun | a chiropteran (nocturnal mouselike mammal |
| | | | with forelimbs modified to form membranous |
| | | | wings and anatomical adaptations for |
| | | | echolocation by which they navigate) |
| (2) | Bat | Noun | a club used for hitting a ball in various |
| | | | games |
| (3) | Bat | Noun | a turn trying to get a hit at baseball |
| (4) | Bat | Verb | to strike with an elongated rod |
| (5) | Bat | Verb | to flutter or wink, as with eyelids |
| (6) | Bat | Verb | to beat thoroughly and conclusively in a |
| | | | competition or fight. |

The analysis set forth in step 104 may also include additional word sense disambiguation, in addition to any disambiguation implemented via the part of speech analysis and/or relation determination, if textual and part of speech analysis results in an identification of multiple word senses. In general, word sense disambiguation involves identifying one or more most likely choices for a word sense used in a given context, when the word/text itself has a number of distinct senses. For example, word sense disambiguation may include analyzing conditional probabilities, for example the probability that a user is concerned with a particular sense given the text/word being analyzed. In other words, conditional probabilities in the form pᵢ=p(senseᵢ|word), i=1, 2, . . . , n for n different word senses are considered to choose the word sense having a greater probability of applicability. Conditional probabilities for various word senses also may be determined utilizing known parts of speech either previously given for the identified text or determined via step 102—e.g., conditional probabilities of the form pᵢ=p(senseᵢ|word, POS), i=1, 2, . . . , n. In other examples, word sense disambiguation may involve more sophisticated probabilistic models such as those possibly from a sense-tagged corpus.

If the information needed for mapping cannot be determined automatically because the information such as part of speech, context or other related information is initially unavailable, it may be possible to prompt a user to enter such information.

For example, once text is identified and a determination is made that there are multiple matching word senses in a database, a graphical user interface may be provided to a user requesting needed information (part of speech, context, etc.). Alternatively, a graphical user interface may depict the different word senses that are found and provide features by which a user can select the appropriate word sense for their intended use of the text.

In a still further alternative, a more specific determination of an appropriate word sense is made after step 106. For example, any identified word senses mapped in step 104, and any symbols associated with such identified word senses may be determined in step 106. After this point, the various symbol options for all possible identified word senses could be displayed to a user via a graphical user interface for user selection of a desired or appropriate symbol for the text identified in step 100.

Referring still to FIG. 1, step 106 involves determining if an identified word sense from step 104 has an associated symbol. If so, then such symbol can be automatically associated with the identified text as part of step 108. Alternatively, such symbol may be displayed graphically to a user for confirmation of association with the identified text. If multiple symbols are matched in step 106, then such multiple symbols may be displayed graphically to a user to prompt user selection of the desired symbol. The identified matching symbol then may be displayed with or without the text as visual output to a user, also as part of step 108. For example, once an identified symbol is associated in step 108, the text may from that point forward be represented in the system as an icon including the symbol with or without the associated text.

If no matching word sense has an associated symbol, then a step 110 may involve an automated determination of whether selected related word senses have an associated symbol. In one embodiment, the determination made in step 110 may involve a first step of selecting one or more word senses that are related to the word senses and a second step of determining whether any of such selected related word senses has an associated symbol. The initial selection of word senses related to the identified word senses can be configured in a variety of fashions based on the fact that relationships among word senses can be defined in a plurality of different ways. For example, word sense relations can be defined in accordance with such non-limiting examples as listed in Table 3 below.

TABLE 3
Exemplary Relations among Text/Words
in a Word Sense Model Database

| Relation Type | Example |
|---|---|
| Kind of | “dog” to “mammal” |
| Part of | “finger” to “hand” |
| Instance of | “Abraham Lincoln” to “President” |
| Used by | “bat” to “batter” |
| Used in | “bat” to “baseball (the game)” |
| Done by | “strike out” to “batter” |
| Done in | “strike out” to “baseball” |
| Found in | “frog” to “pond” |
| Has attribute | “grass” to “green”; “lemon” to “sour” |
| Measure of | “large” to “size” - adjective to noun category it qualifies |
| Related to | “bat” to “Halloween” - generic relationship |
| Similar to | “large” to “immense” - loose synonyms |
| See Also | “afraid” to “cowardly” - very loose synonyms |
| Plural of | “dogs” to “dog” |
| Opposite of | “Bright” to “dark” |

It should be appreciated that word senses may be defined in terms of different relations, but also that some relations can be characterized even more specifically. For example, “kind of” and “part of” relations can further involve a direction of relation, such as more generally related or more specifically related. For example, word sense (1) from Table 2 defining “bat” as a mouselike mammal may be more generally related through a “kind of” relation to the word sense “mammal” or more specifically related through a “kind of” relation to the word sense “vampire bat.” These more general and specific relations applicable to some of relations among words in a word sense model database can also be defined over multiple levels. For example, the “kind of” relation between “bat” and “mammal” may involve one level of separation. However, “kind of” relations between “bat” and “vertebrate” may involve two levels of separation, namely one level from “bat” to “mammal” and a second level from “mammal” to “vertebrate.” As such, all word sense relations can be considered in terms of type (e.g., kind of, part of, instance of, etc.), while some of those types can be further characterized by direction (e.g., general or specific) and degree of separation (e.g., number of levels separating the related word senses).

Because there are so many ways in which the relations can be defined, the determination in step 110 may be preconfigured or customized based on one or more or all of the various types of relations, non-limiting examples of which have been presented in Table 3. For example, step 110 may consider all related word senses or only selected relations. One embodiment may involve determining if particular selected types of related word senses have associated symbols (e.g., only “kind of”, “part of”, “related to”, “similar to”, etc.) The determination in step 110 may involve even further distinctions, such as whether any more general or more specific “kind of” or “part of” word senses related to the identified text have associated symbols. Step 110 may involve determining if any word senses related to the identified text by “part of”, “kind of” or similar relations within a predetermined number of degrees of relational separation (e.g., two or three levels) have associated symbols.

If a related word sense is determined to have an associated symbol in step 110, then that symbol can be associated to the new text and displayed as visual output to a user in step 108. Such visual display may result from automatic association of identified text to the symbol for a related word sense or to presentation of the suggested symbol to a user for confirmation. Again, if multiple word senses are found in step 110, then the possible candidates may be presented to a user for further selection.

In some embodiments, an optional step 111 can involve an automated modification to the symbol stored for a related word sense before it is associated with the identified text in step 108. The automated modification in step 111 can reflect the type of relation to enhance the symbol's appropriateness for a related word sense. For example, given a word sense for “sharp” and a word sense for “dull” that are related to one another by an “opposite of” relation, and a situation where a symbol exists for “sharp” but not for “dull,” it would not be appropriate to show the “sharp” symbol for “dull” because it is the opposite related word sense. However, a modification of the “sharp” symbol with a slash or “X” symbol through it might be appropriate and could be implemented in step 111. Additional variations implemented in step 111 could involve adding a name, number, or identifying image, or creating a variation to or multiplicity of an existing image in the related symbol to identify the type of relation between the identified text and the related symbol. For example, the plural version of a symbol could be modified by adding a plus sign (+) in the corner of the symbol. Alternatively, the plural version of a symbol could be modified by showing a composite symbol having several examples of the singular symbol. In other examples, the number of degrees of relational separation for relations such as “part of” or “kind of” could be indicated with the symbol.

If word sense relation criteria are exhausted and no associated symbols are found, then additional steps can be taken. For example, an optional step 112 may involve providing a symbol menu or other graphical user interface to a user so that the user can manually select a pre-existing or imported symbol for the text, create a symbol from scratch or from predefined symbol selection or creation features, or modify an existing or imported symbol. Once the new symbols is selected, created or modified by a user in step 112, it may then be associated with the identified text for subsequent display and implementation within an electronic device per step 108.

The symbols discussed herein may correspond to a graphical image, or may correspond to different file formats such as an audio file, video file or the like. In some examples, a symbol may be configured manually (by electronic user input) or automatically by the subject symbol assignment system features to include some combination of graphic image, sound, motion, action/behavior and/or other effects and/or specialized user customization. For example, text with an automatically associated symbol may be configured as a graphical interface element having an associated action, thus functioning as a “button” in graphical user interfaces. In a speech generation device, a button having a symbol and/or text may be selected by a user via a touch screen input device. The action resulting from this selection then may correspond to speaking the text corresponding to such symbol and/or placement of the selected text/symbol into a message window for further message composition.

Symbols that are associated with a particular word sense, text, or the like may be stored in the same or a separate database as the word sense model database previously mentioned. Additional discussion of such data storage will follow with reference to FIGS. 4 and 5. It should be generally appreciated that mappings and associations of related information as discussed herein may include storage of mapped or associated information in a common data storage location or instead storage of just a file pointer or other reference to the mapped or associated information.

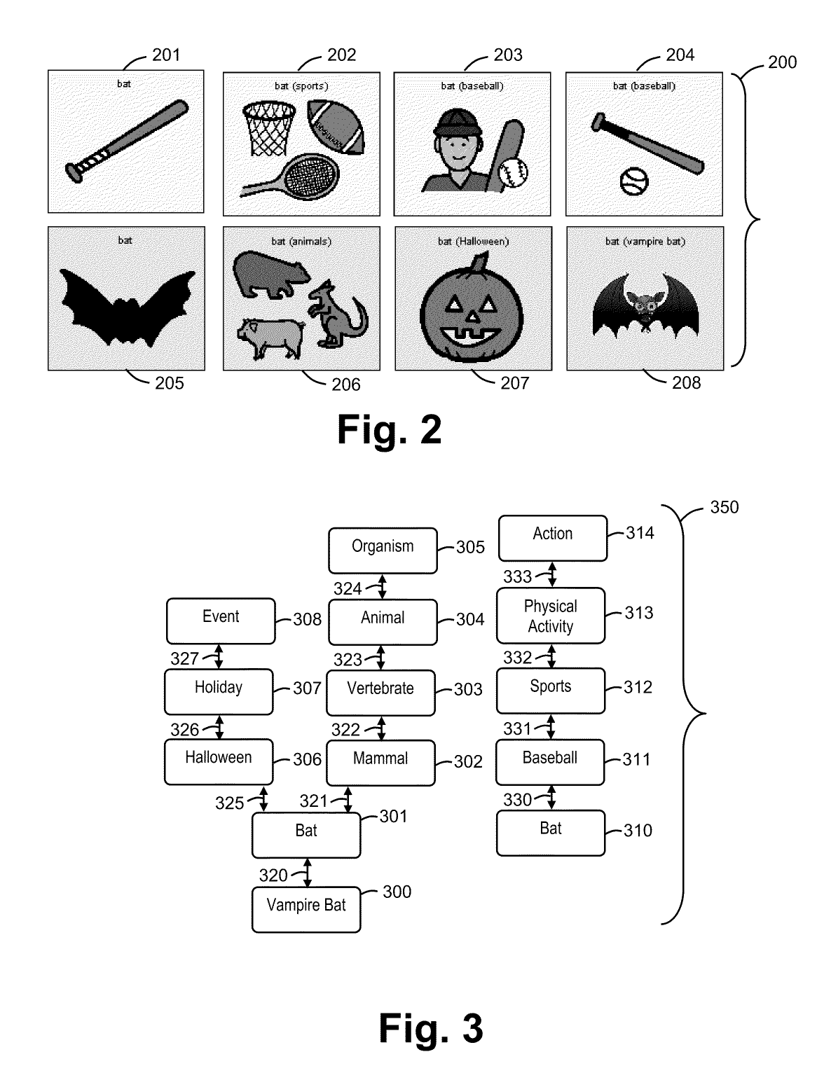

Referring again to the exemplary analysis of the text “bat,” FIGS. 2 and 3 provide exemplary details intending to assist with an understanding of the steps in FIG. 1. FIG. 2 depicts a collection 200 of exemplary graphical elements 201-208, showing various text and symbol combinations. FIG. 3 depicts a partial semantic network 350 of word sense relations.

With more particular reference to exemplary analysis of the text “bat,” assume that the text “bat” is provided in step 100 and a part of speech tagging analysis performed in step 102 results in an indication that the text “bat” is being used or is intended for use as a noun. An analysis of a word sense database in step 104 may identify three word senses for the text “bat” used as a noun—namely, word senses (1), (2) and (3) listed in Table 2 above. A determination is then made in step 106 as to whether any of these three word senses has any associated symbol(s). For example, word sense (1) of Table 2 identifying “bat” as a nocturnal mouselike mammal may have an associated symbol such as shown in graphical element 204 of FIG. 2. Word sense (2) of Table 2 identifying a “bat” as a club used for hitting a ball in various games may have an associated symbol such as shown in graphical element 201 of FIG. 2. Word sense (3) of Table 2 identifying a “bat” as a turn trying to hit a baseball may have an associated symbol such as shown in graphical element 201 or graphical element 203 of FIG. 2. If only one symbol was located, then such symbol could either be automatically matched to the text “bat” or such symbol could be automatically populated on a user display for manual confirmation by the user to match the identified symbol with the text “bat.”

Referring still to the “bat” example, it may be possible that none of the symbols shown in graphical elements 201 or 204 is discovered or available in the system. In that case, related word senses may be analyzed to discover possible symbols for the “bat” text. An exemplary schematic representation of a portion of the word senses related to some different word senses for “bat” is provided in FIG. 3. The different block elements 300-314, respectively, represent different word senses and the bi-directional arrows between the word senses represent the type of relation. Since only portions of the possible set of relations among elements is shown in FIG. 3, it should be appreciated that word sense relations as discussed herein are more accurately represented by a web of related senses as opposed to the limited selection of relation chains shown in FIG. 3.

With more particular reference to FIG. 3, assume that the word sense (1) from Table 2 in which a bat is identified as a nocturnal mouselike mammal corresponds to element 301 in FIG. 3. Word sense model relations as established and stored in a word sense model database may indicate that “bat” 301 is more generally represented as a “mammal” 302, even more generally as a “vertebrate” 303, an “animal” 304 and ultimately an “organism” 305. “Bat” 301 also can be more specifically represented as a “vampire bat” 300. The relations 320, 321, 322, 323 and 324 may all be “kind of” relations a “vampire bat” 300 is a kind of a “bat” 301, a “bat” 301 is a kind of a “mammal” 302, a “mammal” is a kind of a “vertebrate” 303, a “vertebrate” 303 is a kind of an “animal” 304, and an “animal” 304 is a kind of an “organism” 305. The relations 321, 322, 323 and 324 are all more general “kind of” relations relative to “bat” 301, while relation 320 is a more specific “kind of” relation relative to “bat” 301.

The same word sense (1) from Table 2 also may be mapped to relational information tracking from “bat” 301 to “Halloween” 306 to “holiday” 307 to “event” 308. Although the relations among elements 301-305, respectively, are homogeneous in the sense that they are all related by “kind of” relations, elements 301 and 306-308, respectively, are heterogeneous in nature. So, for example, the relation 325 may be defined as a “related to” relation since “bat” 301 is related to “Halloween” 306. Relation 326 may be defined, for example, as an “instance of” since “Halloween” 306 is a specific instance of a “holiday” 307. Relation 327 may be defined as a “kind of” relation since a “holiday” 307 is a kind of an “event” 308.

Referring still to FIG. 3, a separate track of relational information, such as may be associated with word senses (2) and/or (3) from Table 2 may indicate that “bat” 310 is associated with the more general word sense of “baseball” 311 then “sports” 312, then “physical activity” 313 and then “action” 314. Relation 330 may be defined as a “used in” relation since “bat” 310 is used in “baseball (the sport).” Relation 331 may be defined as an “kind of” relation since “baseball” 311 is a kind of a “sport” 312. Relations 332 and 333 may be “kind of” relations since a “sport” 312 is a kind of a “physical activity” 313 and a “physical activity” is a kind of an “action” 314.

In the current example, step 110 depicted in FIG. 1 may correspond to a search and determination of symbols for other word senses related to word senses “bat” 301 and 310. It should be appreciated that the actual determination may involve searching in a greater or fewer number of related word senses than that shown in FIG. 3. For example, if a search per step 106 of the word senses “bat” 301 and/or “bat” 310 yields no associated symbols, then the subject system and method could search related word senses for associated symbols. If a more general and/or specific word sense did have an associated symbol, then step 108 may automatically associate or automatically display for user confirmation one of those related symbols. For example, assuming the analyzed word sense corresponds to word sense (1) from Table 2, e.g., word sense 301 from FIG. 3, and no symbols existed for this word sense, but symbols did exist for the more general related word senses “animal” 304 and/or “Halloween” 306 and/or “vampire bat” (such as shown in graphical elements 206, 207 and 208 of FIG. 2), the symbols for “animal”, “Halloween”, or “vampire bat” then could be automatically associated with the word sense for “bat” or displayed to a user for selection and approval. Similarly, if the analyzed word sense corresponds to word sense (2) from Table 2, e.g., word sense 310 in FIG. 3, and no symbols existed for this word sense, but symbols did exist for the related word sense for “baseball” 311 and “sports” 312 (such as shown in respective graphical elements 203/204 and 202 of FIG. 2), then those symbols could be automatically associated with the word sense for “bat” 310 or displayed to a user for selection and approval.

Referring now to FIGS. 4 and 5, additional details regarding possible hardware components that may be provided to accomplish the methodology described with respect to FIGS. 1, 2 and 3 are discussed.

FIG. 4 discloses an exemplary electronic device 400, which may correspond to any general electronic device including such components as a computing device 401, an input device 410 and an output device 412. In more specific examples, electronic device 400 may correspond to a mobile computing device, a handheld computer, a mobile phone, a cellular phone, a VoIP phone, a smart phone, a personal digital assistant (PDA), a BLACKBERRY™ device, a TREO™, an iPhone™, an iTouch™, a media player, a navigation device, an e-mail device, a game console or other portable electronic device, a stand-alone computer terminal such as a desktop computer, a laptop computer, a netbook computer, a palmtop computer, or a combination of any two or more of the above or other data processing devices.

Referring more particularly to the exemplary hardware shown in FIG. 4, a computing device 401 is provided to function as the central controller within the electronic device 400 and may generally include such components as at least one memory/media element or database for storing data and software instructions as well as at least one processor. In the particular example of FIG. 4, one or more processor(s) 402 and associated memory/media devices 404a, 404b and 404c are configured to perform a variety of computer-implemented functions (i.e., software-based data services). One or more processor(s) 402 within computing device 401 may be configured for operation with any predetermined operating systems, such as but not limited to Windows XP, and thus is an open system that is capable of running any application that can be run on Windows XP. Other possible operating systems include BSD UNIX, Darwin (Mac OS X), Linux, SunOS (Solaris/OpenSolaris), and Windows NT (XP/Vista/7).

At least one memory/media device (e.g., device 404a in FIG. 4) is dedicated to storing software and/or firmware in the form of computer-readable and executable instructions that will be implemented by the one or more processor(s) 402. Other memory/media devices (e.g., memory/media devices 404b and/or 404c as well as databases 406, 407 and 408) are used to store data which will also be accessible by the processor(s) 402 and which will be acted on per the software instructions stored in memory/media device 404a. Computing/processing device(s) 402 may be adapted to operate as a special-purpose machine by executing the software instructions rendered in a computer-readable form stored in memory/media element 404a. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific integrated circuits.

The various memory/media devices of FIG. 4 may be provided as a single portion or multiple portions of one or more varieties of computer-readable media, such as but not limited to any combination of volatile memory (e.g., random access memory (RAM, such as DRAM, SRAM, etc.)) and nonvolatile memory (e.g., ROM, flash, hard drives, magnetic tapes, CD-ROM, DVD-ROM, etc.) or any other memory devices including diskettes, drives, other magnetic-based storage media, optical storage media and others. In some embodiments, at least one memory device corresponds to an electromechanical hard drive and/or or a solid state drive (e.g., a flash drive) that easily withstands shocks, for example that may occur if the electronic device 400 is dropped. Although FIG. 4 shows three separate memory/media devices 404a, 404b and 404c, and three separate databases 406, 407 and 408, the content dedicated to such devices may actually be stored in one memory/media device or in multiple devices. Any such possible variations and other variations of data storage will be appreciated by one of ordinary skill in the art.

In one particular embodiment of the present subject matter, memory/media device 404b is configured to store input data received from a user, such as but not limited to information corresponding to or identifying text (e.g., one or more words, phrases, acronyms, identifiers, etc.) for performing the desired symbol assignment analysis, and any optional related information such as part of speech, context and the like. Such input data may be received from one or more integrated or peripheral input devices 410 associated with electronic device 400, including but not limited to a keyboard, joystick, switch, touch screen, microphone, eye tracker, camera, or other device. Memory device 404a includes computer-executable software instructions that can be read and executed by processor(s) 402 to act on the data stored in memory/media device 404b to create new output data (e.g., audio signals, display signals, RF communication signals and the like) for temporary or permanent storage in memory, e.g., in memory/media device 404c. Such output data may be communicated to integrated and/or peripheral output devices, such as a monitor or other display device, or as control signals to still further components.

Additional actions taken by the processor(s) 402 within computing device 401 may access and/or analyze data stored in one or more databases, such as word sense database 406, language database 407 and symbol database 408, which may be provided locally relative to computing device 401 (as illustrated in FIG. 4) or in a remote location accessible via a wired and/or wireless communication link.

In general, word sense database 406 and language database 407 work together to define all the informational characteristics of a given text/word. Word sense database 406 stores a plurality of entries that identify the different possible meanings for various text/word items, while the actual language-specific identifiers for such meanings (i.e., the words themselves) are stored in language database 407. The entries in the word sense database 406 are thus cross-referenced to entries in language database 407 which provide the actual labels for a word sense. As such, word sense database 406 generally stores semantic information about a given word while language database 407 generally stores the lexical information about a word.

The basic structure of the databases 406 and 407 is such that the word sense database is effectively language-neutral. Because of this structure and the manner in which the word sense database 406 functionally interacts with the language database 407, different language databases (e.g., English, French, German, Spanish, Chinese, Japanese, etc.) can be used to map to the same word sense entries stored in word sense database 406. Considering again the “bat” example, an entry for “bat” in an English language database (one particular embodiment of language database 407) may be cross-referenced to six different entries in word sense database 406, all of which are outlined in Table 2 above. However, an entry for “chauve-souris” in a French language database 407 (another particular embodiment of language database 407) would be linked to the first word sense in Table 2 correlating the semantic meaning of a nocturnal mouselike mammal, while an entry for “batte” in the same French language database would be linked to the second word sense in Table 2 correlating the meaning of a club used for hitting a ball.

The word sense database 406 also stores information defining the relations among the various word senses. For example, an entry in word sense database 406 may also store information associated with the word entry defining which word senses it is related to by various predefined relations as described above in Table 3. It should be appreciated that although relation information is stored in word sense database 406 in one exemplary embodiment, other embodiments may store such relation information in other databases such as the language database 407 or symbol database 408, or yet another database specifically dedicated to relation information, or a combination of one or more of these and other databases.

The language database 407 may also store related information for each word entry. For example, optional additional lexical information such as but not limited to definitions, parts of speech, different regular and/or irregular forms of such words, pronunciations and the like may be stored in language database 407. For each word, probabilities for part of speech analysis as determined from a tagged corpus such as but not limited to the Brown corpus, American National Corpus, etc., may also be stored in language database 407. Part of speech data for each entry in a language database may also be provided from customized or preconfigured tagset sources. Nonlimiting examples of part of speech tagsets that could be used for analysis in the subject text mapping and analysis are the Penn Treebank documentation (as defined by Marcus et al., 1993, “Building a large annotated corpus of English: The Penn Treebank,” Computational Linguistics, 19(2): 313-330), and the CLAWS (Constituent Likelihood Automatic Word-tagging System) series of tagsets (e.g., CLAWS4, CLAWS5, CLAWS6, CLAWS7) developed by UCREL of Lancaster University in Lancaster, United Kingdom.

In some embodiments of the subject technology, the information stored in word sense database 406 and language database 407 is customized according to the needs of a user and/or device. In other embodiments, preconfigured collective databases may be used to provide the information stored within databases 406 and 407. Non-limiting examples of preconfigured lexical and semantic databases include the WordNet lexical database created and currently maintained by the Cognitive Science Laboratory at Princeton University of Princeton, N.J., the Semantic Network distributed by UMLS Knowledge Sources and the U.S. National Library of Medicine of Bethesda, Md., or other preconfigured collections of lexical relations. Such lexical databases and others store groupings of words into sets of synonyms that have short, general definitions, as well as the relations between such sets of words.

Symbol database 408 may correspond to a database of graphical images, as well as additional optional features such as audio files, video or animated graphic files, action items, or other features. One example of a symbol database for use with the subject technology corresponds to that available as part of the Boardmaker Plus! brand software available from DynaVox Mayer-Johnson of Pittsburgh, Pa.

It should be appreciated that the hardware components illustrated in and discussed with reference to FIG. 4 may be selectively combined with additional components to create different electronic device embodiments for use with the presently disclosed symbol assignment technology. For example, the same or similar components provided in FIG. 4 may be integrated as part of a speech generation device (SGD) or AAC device 500, as shown in the example of FIG. 5. AAC device 500 may correspond to a variety of devices such as but not limited to a device such as offered for sale by DynaVox Mayer-Johnson of Pittsburgh, Pa. including but not limited to the V, Vmax, Xpress, Tango, M³ and/or DynaWrite products or any other suitable component adapted with the features and functionality disclosed herein.

Central computing device 501 may include all or part of the functionality described above with respect to computing device 401, and so a description of such functionality is not repeated. Memory device or database 504a of FIG. 5 may include some of all of the memory elements 404a, 404b and/or 404c as described above relative to FIG. 4. Memory device or database 504b of FIG. 5 may include some or all of the databases 406, 407 and 408 described above relative to FIG. 4. Input device 410 and output device 412 may correspond to one or more the input and output devices described below relative to FIG. 5.

Referring still to FIG. 5, central computing device 501 also may include a variety of internal and/or peripheral components in addition to similar components as described with reference to FIG. 4. Power to such devices may be provided from a battery 503, such as but not limited to a lithium polymer battery or other rechargeable energy source. A power switch or button 505 may be provided as an interface to toggle the power connection between the battery 503 and the other hardware components. In addition to the specific devices discussed herein, it should be appreciated that any peripheral hardware device 507 may be provided and interfaced to the speech generation device via a USB port 509 or other communicative coupling. It should be further appreciated that the components shown in FIG. 5 may be provided in different configurations and may be provided with different arrangements of direct and/or indirect physical and communicative links to perform the desired functionality of such components.

In general, the electronic components of an SGD 500 enable the device to transmit and receive messages to assist a user in communicating with others. For example, the SGD may correspond to a particular special-purpose electronic device that permits a user to communicate with others by producing digitized or synthesized speech based on configured messages. Such messages may be preconfigured and/or selected and/or composed by a user within a message window provided as part of the speech generation device user interface. As will be described in more detail below, a variety of physical input devices and software interface features may be provided to facilitate the capture of user input to define what information should be displayed in a message window and ultimately communicated to others as spoken output, text message, phone call, e-mail or other outgoing communication.

With more particular reference to exemplary speech generation device 500 of FIG. 5, various input devices may be part of an SGD 500 and thus coupled to the computing device 501. For example, a touch screen 506 may be provided to capture user inputs directed to a display location by a user hand or stylus. A microphone 508, for example a surface mount CMOS/MEMS silicon-based microphone or others, may be provided to capture user audio inputs. Other exemplary input devices (e.g., peripheral device 510) may include but are not limited to a peripheral keyboard, peripheral touch-screen monitor, peripheral microphone, mouse and the like. A camera 519, such as but not limited to an optical sensor, e.g., a charged coupled device (CCD) or a complementary metal-oxide semiconductor (CMOS) optical sensor, or other device can be utilized to facilitate camera functions, such as recording photographs and video clips, and as such may function as another input device. Hardware components of SGD 500 also may include one or more integrated output devices, such as but not limited to display 512 and/or speakers 514.

Display device 512 may correspond to one or more substrates outfitted for providing images to a user. Display device 512 may employ one or more of liquid crystal display (LCD) technology, light emitting polymer display (LPD) technology, light emitting diode (LED), organic light emitting diode (OLED) and/or transparent organic light emitting diode (TOLED) or some other display technology. Additional details regarding OLED and/or TOLED displays for use in SGD 500 are disclosed in U.S. Provisional Patent Application No. 61/250,274 filed Oct. 9, 2009 and entitled “Speech Generation Device with OLED Display,” which is hereby incorporated herein by reference in its entirety for all purposes.

In one exemplary embodiment, a display device 512 and touch screen 506 are integrated together as a touch-sensitive display that implements one or more of the above-referenced display technologies (e.g., LCD, LPD, LED, OLED, TOLED, etc.) or others. The touch sensitive display can be sensitive to haptic and/or tactile contact with a user. A touch sensitive display that is a capacitive touch screen may provide such advantages as overall thinness and light weight. In addition, a capacitive touch panel requires no activation force but only a slight contact, which is an advantage for a user who may have motor control limitations. Capacitive touch screens also accommodate multi-touch applications (i.e., a set of interaction techniques which allow a user to control graphical applications with several fingers) as well as scrolling, In some implementations, a touch-sensitive display can comprise a multi-touch-sensitive display. A multi-touch-sensitive display can, for example, process multiple simultaneous touch points, including processing data related to the pressure, degree, and/or position of each touch point. Such processing facilitates gestures and interactions with multiple fingers, chording, and other interactions. Other touch-sensitive display technologies also can be used, e.g., a display in which contact is made using a stylus or other pointing device. Some examples of multi-touch-sensitive display technology are described in U.S. Pat. No. 6,323,846 (Westerman et al.), U.S. Pat. No. 6,570,557 (Westerman et al.), U.S. Pat. No. 6,677,932 (Westerman), and U.S. Pat. No. 6,888,536 (Westerman et al.), each of which is incorporated by reference herein in its entirety for all purposes.

Speakers 514 may generally correspond to any compact high power audio output device. Speakers 514 may function as an audible interface for the speech generation device when computer processor(s) 502 utilize text-to-speech functionality. Speakers can be used to speak the messages composed in a message window as described herein as well as to provide audio output for telephone calls, speaking e-mails, reading e-books, and other functions. A volume control module 522 may be controlled by one or more scrolling switches or touch-screen buttons.

SGD hardware components also may include various communications devices and/or modules, such as but not limited to an antenna 515, cellular phone or RF device 516 and wireless network adapter 518. Antenna 515 can support one or more of a variety of RF communications protocols. A cellular phone or other RF device 516 may be provided to enable the user to make phone calls directly and speak during the phone conversation using the SGD, thereby eliminating the need for a separate telephone device. A wireless network adapter 518 may be provided to enable access to a network, such as but not limited to a dial-in network, a local area network (LAN), wide area network (WAN), public switched telephone network (PSTN), the Internet, intranet or ethernet type networks or others. Additional communications modules such as but not limited to an infrared (IR) transceiver may be provided to function as a universal remote control for the SGD that can operate devices in the user's environment, for example including TV, DVD player, and CD player.

When different wireless communication devices are included within an SGD, a dedicated communications interface module 520 may be provided within central computing device 501 to provide a software interface from the processing components of computer 501 to the communication device(s). In one embodiment, communications interface module 520 includes computer instructions stored on a computer-readable medium as previously described that instruct the communications devices how to send and receive communicated wireless or data signals. In one example, additional executable instructions stored in memory associated with central computing device 501 provide a web browser to serve as a graphical user interface for interacting with the Internet or other network. For example, software instructions may be provided to call preconfigured web browsers such as Microsoft® Internet Explorer or Firefox® internet browser available from Mozilla software.

Antenna 515 may be provided to facilitate wireless communications with other devices in accordance with one or more wireless communications protocols, including but not limited to BLUETOOTH, WI-FI (802.11 b/g), MiFi and ZIGBEE wireless communication protocols. In one example, the antenna 515 enables a user to use the SGD 500 with a Bluetooth headset for making phone calls or otherwise providing audio input to the SGD. The SGD also can generate Bluetooth radio signals that can be used to control a desktop computer, which appears on the SGD's display as a mouse and keyboard. Another option afforded by Bluetooth communications features involves the benefits of a Bluetooth audio pathway. Many users utilize an option of auditory scanning to operate their SGD. A user can choose to use a Bluetooth-enabled headphone to listen to the scanning, thus affording a more private listening environment that eliminates or reduces potential disturbance in a classroom environment without public broadcasting of a user's communications. A Bluetooth (or other wirelessly configured headset) can provide advantages over traditional wired headsets, again by overcoming the cumbersome nature of the traditional headsets and their associated wires.

When an exemplary SGD embodiment includes an integrated cell phone, a user is able to send and receive wireless phone calls and text messages. The cell phone component 516 shown in FIG. 5 may include additional sub-components, such as but not limited to an RF transceiver module, coder/decoder (CODEC) module, digital signal processor (DSP) module, communications interfaces, microcontroller(s) and/or subscriber identity module (SIM) cards. An access port for a subscriber identity module (SIM) card enables a user to provide requisite information for identifying user information and cellular service provider, contact numbers, and other data for cellular phone use. In addition, associated data storage within the SGD itself can maintain a list of frequently-contacted phone numbers and individuals as well as a phone history or phone call and text messages. One or more memory devices or databases within a speech generation device may correspond to computer-readable medium that may include computer-executable instructions for performing various steps/tasks associated with a cellular phone and for providing related graphical user interface menus to a user for initiating the execution of such tasks. The input data received from a user via such graphical user interfaces can then be transformed into a visual display or audio output that depicts various information to a user regarding the phone call, such as the contact information, call status and/or other identifying information. General icons available on SGD or displays provided by the SGD can offer access points for quick access to the cell phone menus and functionality, as well as information about the integrated cell phone such as the cellular phone signal strength, battery life and the like.

Operation of the hardware components shown in FIGS. 4 and 5 to create specific associations of text to symbols can be particularly advantageous for creating new graphical interface features to facilitate a user's interaction with an electronic device, particularly a speech generation device 500 as shown in FIG. 5. Such user interfaces correspond to respective visual transformations of computer instructions that have been executed by a processor associated with a device. Visual output corresponding to a graphical user interface, including text, symbols, icons, menus, templates, so-called “buttons” or other features may be displayed on an output device associated with an electronic device such as an AAC device or mobile device.

Buttons or other features can provide a user interface element by which a user can select additional interface options or language elements. Such user interface features then may be selectable by a user (e.g., via an input device, such as a mouse, keyboard, touchscreen, eye gaze controller, virtual keypad or the like). When selected, the user input features can trigger control signals that can be relayed to the central computing device within an SGD to perform an action in accordance with the selection of the user buttons. Such additional actions may result in execution of additional instructions, display of new or different user interface elements, or other actions as desired. As such, user interface elements also may be viewed as display objects, which are graphical representations of system objects that are selectable by a user. Some examples of system objects include device functions, applications, windows, files, alerts, events or other identifiable system objects.

User interface buttons or other elements also may correspond to language elements and can be activated by user selection to “speak” words or phrases. Speaking consists of playing a recorded message or sound or speaking text using a voice synthesizer. In accordance with such functionality, some user interfaces are provided with a “Message Window” in which a user provides text, symbols corresponding to text, and/or related or additional information which then may be interpreted by a text-to-speech engine and provided as audio output via device speakers. Speech output may be generated in accordance with one or more preconfigured text-to-speech generation tools in male or female and adult or child voices, such as but not limited to such products as offered for sale by Cepstral, HQ Voices offered by Acapela, Flexvoice offered by Mindmaker, DECtalk offered by Fonix, Loquendo products, VoiceText offered by NeoSpeech, products by AT&T's Natural Voices offered by Wizzard, Microsoft Voices, digitized voice (digitally recorded voice clips) or others.

Referring now to FIG. 6, a flow chart is presented to illustrate basic steps in one example of a part-of-speech tagging process in accordance with the present technology. A first step 602 involves identifying text to be analyzed, and extracting an observation sequence including the identified text. Usually the analyzed text (i.e., the observation sequence) will include a plurality of words strung together in one or more sentences, portions of sentences, clauses or other subset of words. Even if part-of-speech tagging is desired for only one word in an observation sequence, additional surrounding words are typically analyzed by the part-of-speech tagging algorithm to better optimize the tagging accuracy. Some of the following description may describe the observation sequence as a sentence, although it should be appreciated that other subsets of words/text may be analyzed. Step 604 involves providing POS tagging data required to perform probability analyses for the different words in the observation sequence. POS tagging data provided in step 604 may include such information as a list of all possible tags in a tagset, information identifying the number of words in the lexicon of the system, and probabilities establishing the likelihoods that each word will have a part of speech given various known uses of the word. Such probabilities may be determined by using a pre-tagged language corpus which studies the actual occurrences of various words and determines the probabilities that each word will correspond to a particular part of speech. Examples of such pre-tagged corpuses may include the Brown Corpus, American National Corpus and others.

Referring still to FIG. 6, probability computations are then conducted in step 606 for each word in the observation sequence, such as may be implemented using the HMM based modeling techniques described below. Depending on the exact type of modeling technique used (e.g., first or second order Viterbi algorithm with or without forward-backward algorithm variations, or other models), different output steps may be implemented such as represented by steps 608 and 610. In one example, step 608 involves identifying the most likely part of speech for each word in the observation sequence, such as would be determined using a Viterbi algorithm or comparable method. In another example, step 610 involves identifying a list of possible tags and corresponding probabilities of occurrence for some or all of the words in the observation sequence. In one example, the outputs identified in step 608 are determined using a Viterbi-based algorithm, and the outputs identified in step 610 are determined using a forward-backward algorithm. A combination of steps 608 and 610 may be used to provide different outputs for a user, depending on user preferences.

Many part-of-speech tagging algorithms are based on the principles of hidden Markov models (HMMs), a well developed statistical construct used to solve state sequence classification problems in which states are interconnected by a set of transition probabilities. When using HMMs to perform part-of-speech tagging, the goal is to determine the most likely sequence of tags (states) that generates the words in a sentence or other subset of text (sequence of output symbols). In other words, given a sentence V, calculate the sequence U of tags that maximizes P(V|U). The Viterbi algorithm is a common method for calculating the most likely tag sequence when using an HMM. Particular details regarding the implementation of HMM-based tagging via the Viterbi algorithm are disclosed in “A Tutorial on Hidden Markov Models and Selected Applications in Speech Recognition,” by Lawrence R. Rabiner, Proceedings of the IEEE, Vol. 77, No. 2, February 1989, pp. 257-286. According to this implementation, there are five elements needed to define an HMM:
1. N, the number of distinct states in the model. For part of speech tagging, N is the number of tags that can be used by the system. Each possible tag for the system corresponds to one state of the HMM.
2. M, the number of distinct output symbols in the alphabet of the HMM. For part of speech tagging, M is the number of words in the lexicon of the system.
3. A={aᵢⱼ}, the state transition probability distribution. The probability aᵢⱼ is the probability that the process will move from state i to state j in one transition. For part-of-speech tagging, the states represent the tags, so aᵢⱼ is the probability that the model will move from tᵢ to tⱼ—in other words, the probability that tag tⱼ follows tᵢ. This probability can be estimated using data from a training corpus.
4. B={bⱼ(k)}, the observation symbol probability distribution. The probability bⱼ(k) is the probability that the k-th output symbol will be emitted when the model is in state j. For part-of-speech tagging, this is the probability that the word wₖ will be emitted when the system is at tag tⱼ (i.e., P(wₜ|tⱼ)). This probability can also be estimated using data from a training corpus.
5. π={πᵢ}, the initial state distribution. πᵢ is the probability that the model will start in state i. For part-of-speech tagging, this is the probability that a given sentence will begin with tag tᵢ.
   With the above information being identified, the Viterbi algorithm determines the most likely sequence of tags (states) that generates the words in the sentences (sequence of output symbols). In other words, given a sentence V, the system calculates the sequence U of tags that maximizes P(V|U). The results thus provide part-of-speech tags for a whole sentence or subset of words based on the analysis of all words in the subset. This model is an example of a first-order hidden Markov model. In part-of-speech tagging, it is called a bigram tagger.

Another example of an algorithm that can be used is a variation on the above process, implemented as a second-order Markov model or tri-gram tagger. In general, a trigram model replaces the bigram transition probability aᵢⱼ=P(tₚ=tⱼ|tₚ₋₁=tᵢ) with a trigram probability aᵢⱼₖ=P(tₚ=tₖ|tₚ₋₁=tⱼ, tₚ₋₂=tᵢ). A second-order Viterbi algorithm could then be applied to such a model using similar principles to those described above.

Variations to the bigram and trigram tagging approaches described above may also be implemented in some embodiments of the disclosed technology. For example, steps may be taken to provide information identifying a list of possible tags and their probability given the textual input sequence instead of just a single most likely tag for each word in the sequence. This additional information may help more readily disambiguate among two or more POS tags for a word. One exemplary approach for calculating such probabilities is with the so-called “Forward-Backward” algorithm (see, e.g., “Foundations of Statistical Natural Language Processing,” by C. D. Manning and H. Shutze, The MIT Press, Cambridge, Mass. (1999)). The Forward-Backward algorithm computes the sum of the probabilities of all the tag sequences where the i-th tag is t, divided by the sum of the probabilities of all tag sequences. The forward-backward algorithm can be applied as a more comprehensive analysis for either a first-order or second-order Markov model.

Referring now to FIG. 7, a flow chart is provided to depict exemplary steps that may be used in one embodiment of relation determination for identified text (i.e., target words) and surrounding keywords. In general, such process examines the relations among words or word senses that may be stored in a database associated with the subject technology (e.g., one or more of the word sense database 406 or language database 407 illustrated in FIG. 4). A first step in the exemplary process includes step 702 of mapping the target word(s) to one or more word senses. Similarly, other selected surrounding words (i.e., keywords) in an observation sequence are mapped to one or more word senses in step 704 such that the word sense(s) of the target word(s) can be compared to the word sense(s) of the keyword(s) in step 706.

Referring still to FIG. 7, the relation analysis in step 706 generally involves determining whether one or more types of relations exist between the word sense(s) of the target word(s) mapped in step 702 and the word sense(s) of surrounding keyword(s) mapped in step 704. Word senses can be related to one another in a plurality of different ways. For example, word sense relations can be defined in accordance with such non-limiting examples as provided in Table 3 herein.

In one embodiment of step 706, the different word sense(s) that are related to the target word sense(s) are first determined and then searched to identify if such related word senses correspond to any of the word senses mapped in step 704 for the surrounding keyword senses. In another embodiment of step 706, the word sense(s) for the target word identified in step 702 and the word sense(s) for the selected surrounding keyword(s) are provided as input into a relational determining process to provide an indicator of whether the words are related as well as the specific relation(s) between the word senses. Step 706 may further involve as part of its analysis a determination of conditional probabilities that a given target word corresponds to a particular word sense given the results of the relation analysis conducted relative to surrounding words. In other words, conditional probabilities in the form pᵢ=p(senseᵢ|word, keyword context), i=1, 2, . . . , n for n different word senses are considered to choose the word sense having a greater probability of applicability. Either these conditional probabilities or a selection of one or more most likely word senses given the relational analysis performed in steps 702-706 are then provided back to the system for further determination of an appropriate word sense mapping and symbol selection.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of automatically discovering and assigning symbols for identified text in a software application, comprising:
receiving electronic signals indicating identified text for which symbol assignment is desired;
electronically determining one or more most likely part of speech tags for the identified text;
electronically analyzing the identified text and the one or more most likely part of speech tags for the identified text to automatically establish a mapping of the identified text to one or more identified word senses;
electronically determining whether any of the identified word senses has an associated symbol; and
displaying one or more of the electronically determined associated symbols on an electronic display device.

2. The method of claim 1, wherein the part of speech tags from said first electronically determining step are selected from a tagset indicating basic parts of speech as well as syntactic or morpho-syntactic distinctions.

3. The method of claim 1, wherein the part of speech tags from said first electronically determining step are selected from a part of speech tagset containing between 20 and 100 possible tags.

4. The method of claim 1, wherein said step of electronically determining one or more most likely part of speech tags for the identified text comprises:
extracting an observation sequence of text including the identified text and surrounding words; and
assigning the most likely part of speech tag for each word in the observation sequence.

5. The method of claim 4, wherein said assigning step comprises employing one or more of a first-order Viterbi algorithm, a second-order Viterbi algorithm and a forward-backward algorithm to assign part of speech tags.

6. The method of claim 1, wherein said step of electronically determining one or more most likely part of speech tags for the identified text comprises:
extracting an observation sequence of text including the identified text and surrounding words; and
generating a list of possible tags and corresponding probabilities of occurrence for the one or more words in the identified text.

7. The method of claim 1, further comprising:
electronically selecting one or more related word senses that are related to the one or more identified word senses; and
electronically determining whether the one or more selected related word senses has an associated symbol.

8. The method of claim 7, further comprising providing a graphical user interface to a user for manual selection of a symbol to associate with the identified text when said electronically determining steps results in a determination that neither the identified word senses nor the selected related word senses have associated symbols.

9. The method of claim 7, further comprising a step of applying an automated modification to a symbol determined to be associated with a related word sense before displaying such symbol.

10. The method of claim 1, further comprising displaying multiple word senses on a graphical user interface for subsequent user selection when multiple word senses are mapped in said electronically analyzing step or when multiple associated symbols are identified in said second electronically determining step.

11. The method of claim 1, wherein said displaying step more particularly comprises displaying the identified text in conjunction with the assigned selected symbol on an electronic display device.

12. The method of claim 1, further comprising a step of electronically determining relations among the identified text and selected surrounding keywords, and wherein said electronically analyzing step additionally considers any determined relations in mapping the identified text to one or more identified word senses.

13. An electronic device, comprising:
at least one electronic input device configured to receive electronic input from a user indicating identified text for which symbol assignment is desired;
at least one processing device;
at least one memory comprising computer-readable instructions for execution by said at least one processing device, wherein said processing device is configured to determine one or more most likely part of speech tags for the identified text, analyze the identified text and the one or more most likely part of speech tags for the identified text to automatically establish a mapping of the identified text to one or more identified word senses, and determine whether any of the identified word senses has an associated symbol; and
at least one electronic output device configured to display one or more of the electronically determined associated symbols as visual output.

14. The electronic device of claim 13, wherein said electronic device comprises a speech generation device that comprises at least one speaker for providing audio output.

15. The electronic device of claim 13, wherein said processing device is further configured as part of determining one or more most likely part of speech tags for the identified text to extract an observation sequence of text including the identified text and surrounding words, and assign the most likely part of speech tag for each word in the observation sequence by employing one or more of a first-order Viterbi algorithm, a second-order Viterbi algorithm, and a forward-backward algorithm.

16. The electronic device of claim 13, wherein said processing device is further configured as part of determining one or more most likely part of speech tags for the identified text to extract an observation sequence of text including the identified text and surrounding words, and generate a list of possible tags and corresponding probabilities of occurrence for one or more words in the identified text.

17. The electronic device of claim 13, wherein said at least one output device is further configured to display multiple word senses for subsequent user selection when multiple word senses are mapped to the identified text or when multiple symbols are identified as being associated with the identified word senses or selected related word senses.

18. The electronic device of claim 13, wherein said at least one output device is configured to display the identified text in conjunction with an assigned selected symbol.

19. The electronic device of claim 13, wherein said at least one processing device is further configured to electronically determine relations among the identified text and selected surrounding keywords, and wherein the subsequent analysis additionally considers any determined relations in mapping the identified text to one or more identified word senses.

20. The electronic device of claim 13, wherein said at least one processing device is further configured to select one or more related word senses that are related to the one or more identified word senses, and determine whether the one or more selected related word senses has an associated symbol.

21. The electronic device of claim 20, wherein said at least one processing device is further configured to apply an automated modification to a symbol determined to be associated with a related word sense before displaying such symbol.

22. A computer readable medium comprising executable instructions configured to control a processing device to:
receive electronic signals from an input device indicating identified text for which symbol assignment is desired;
electronically determine one or more most likely part of speech tags for the identified text;
electronically analyze the identified text and the one or more most likely part of speech tags for the identified text to automatically establish a mapping of the identified text to one or more identified word senses;
electronically determine whether any of the identified word senses has an associated symbol; and
display one or more of the electronically determined associated symbols on an electronic display device.

23. The computer readable medium of claim 22, wherein said executable instructions are further configured to extract an observation sequence of text including the identified text and surrounding words, and assign the most likely part of speech tag for each word in the observation sequence using one or more of a first-order Viterbi algorithm, a second-order Viterbi algorithm and a forward-backward algorithm.

24. The computer readable medium of claim 22, wherein said executable instructions are further configured to extract a sequence of text including the identified text and surrounding words, and generate a list of possible tags and corresponding probabilities of occurrence for one or more words in the identified text.

25. The computer readable medium of claim 22, wherein said executable instructions are further configured to select one or more related word senses that are related to the one or more identified word senses, and determine whether the one or more selected related word senses has an associated symbol.

26. The computer readable medium of claim 25, wherein said executable instructions are further configured to apply an automated modification to a symbol determined to be associated with a related word sense before displaying such symbol.

27. The computer readable medium of claim 22, wherein said executable instructions are further configured to display multiple word senses on a graphical user interface for subsequent user selection when multiple word senses are mapped via the electronically analyzing step or when multiple associated symbols are identified in said second electronically determining step.
